(19) United States
(12) Patent Application Publication
(10) Pub. No.: US 2012/0167122 A1
(43) Pub. Date: Jun. 28, 2012

(54) METHOD AND APPARATUS FOR PRE-INITIALIZING APPLICATION RENDERING PROCESSES

(75) Inventor: Olli Oskari Koskimies, Helsinki (FI)

(73) Assignee: Nokia Corporation, Espoo (FI)

(21) Appl. No.: 12/979,141

(22) Filed: Dec. 27, 2010

(51) Int. Cl. G06F 9/46

(52) U.S. Cl. 719/328

(57) ABSTRACT

An approach is provided for managing processes for enabling execution of applications within a user device. One or more characteristics of an application are determined by a process monitor module. A process management module then determines a process of the device for execution the application based, at least in part, on the one or more characteristics. A process allocation policy is executed for enabling process allocation decisions.

### BACKGROUND

Service providers and device manufacturers (e.g., wireless, cellular, etc.) are continually challenged to deliver value and convenience to consumers by, for example, providing compelling network services. One area of interest has been the development of applications (e.g., web applications developed using standard web technologies) for delivering these services and other functions through web browsers. For example, as the numbers of operating system platforms (e.g., mobile operating systems) proliferate, service providers are making increasing use of web applications as a means for cross-platform development. However, web applications have traditionally been associated with significantly longer start times than native applications. One factor leading to the longer startup times is the increased overhead and preparation steps associated with initiating rendering processes to support execution of the web applications within browsers. Accordingly, service providers and device manufacturers face significant technical challenges to improving web application startup times.

### SOME EXAMPLE EMBODIMENTS

Therefore, there is a need for an approach for efficiently pre-initializing rendering processes to support execution of applications (e.g., web applications) at a device, particularly devices with relatively limited resources and/or capabilities such as a mobile device (e.g., smartphones, cell phones, etc.).

According to one embodiment, a method comprises processing and/or facilitating a processing of one or more characteristics of at least one application for rendering at a device. The method also comprises causing, at least in part, an initialization of at least a portion of at least one rendering process at the device for supporting the at least one application based, at least in part, on the one or more characteristics. The initialization occurs prior to receiving a request to initiate an execution instance of the at least one application.

According to another embodiment, an apparatus comprises at least one processor, and at least one memory including computer program code, the at least one memory and the computer program code configured to, with the at least one processor, cause, at least in part, the apparatus to process and/or facilitate a processing of one or more characteristics of at least one application for rendering at a device. The apparatus is also causes, at least in part, an initialization of at least a portion of at least one rendering process at the device for supporting the at least one application based, at least in part, on the one or more characteristics. The initialization occurs prior to receiving a request to initiate an execution instance of the at least one application.

According to another embodiment, a computer-readable storage medium carries one or more sequences of one or more instructions which, when executed by one or more processors, cause, at least in part, an apparatus to process and/or facilitate a processing of one or more characteristics of at least one application for rendering at a device. The apparatus is also causes, at least in part, an initialization of at least a portion of at least one rendering process at the device for supporting the at least one application based, at least in part, on the one or more characteristics. The initialization occurs prior to receiving a request to initiate an execution instance of the at least one application.

According to another embodiment, an apparatus comprises means for processing and/or facilitating a processing of one or more characteristics of at least one application for rendering at a device. The apparatus also comprises means for causing, at least in part, an initialization of at least a portion of at least one rendering process at the device for supporting the at least one application based, at least in part, on the one or more characteristics. The initialization occurs prior to receiving a request to initiate an execution instance of the at least one application.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of pre-initializing application rendering processes, according to one embodiment;

FIG. 2 is a diagram of the components of a process management platform, according to one embodiment;

FIG. 3A is a diagram of a data structure representative of application characteristic data for enabling pre-initialization of application rendering processes, according to one embodiment;

FIG. 3B is a diagram of a data structure representative of rules for enabling pre-initialization of application rendering processes, according to one embodiment;

FIG. 4 is a flowchart of a process for pre-initializing application rendering processes, according to one embodiment, according to one embodiment;

FIG. 5 is a flowchart of a process for initiating an execution instance of an application based on a pool of pre-initialized rendering processes, according to one embodiment;

FIGS. 6A and 6B are diagrams of interactions between a client and a server utilized in data mining included in the pre-initialization processes of FIGS. 1-5, according to various embodiments, according to various embodiments;

FIGS. 7A and 7B are diagram of user interfaces used in the processes of FIGS. 4 and 5, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for pre-initializing application rendering processes are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention. Although various embodiments are described with respect to user devices such as mobile phones, Smartphones, computing devices, etc., it is contemplated the approach described herein may be used with other communication devices.

Although various embodiments are described with respect to web applications, it is contemplated that the various embodiments of the approach described herein are applicable to any application execution within an interpreted code environment.

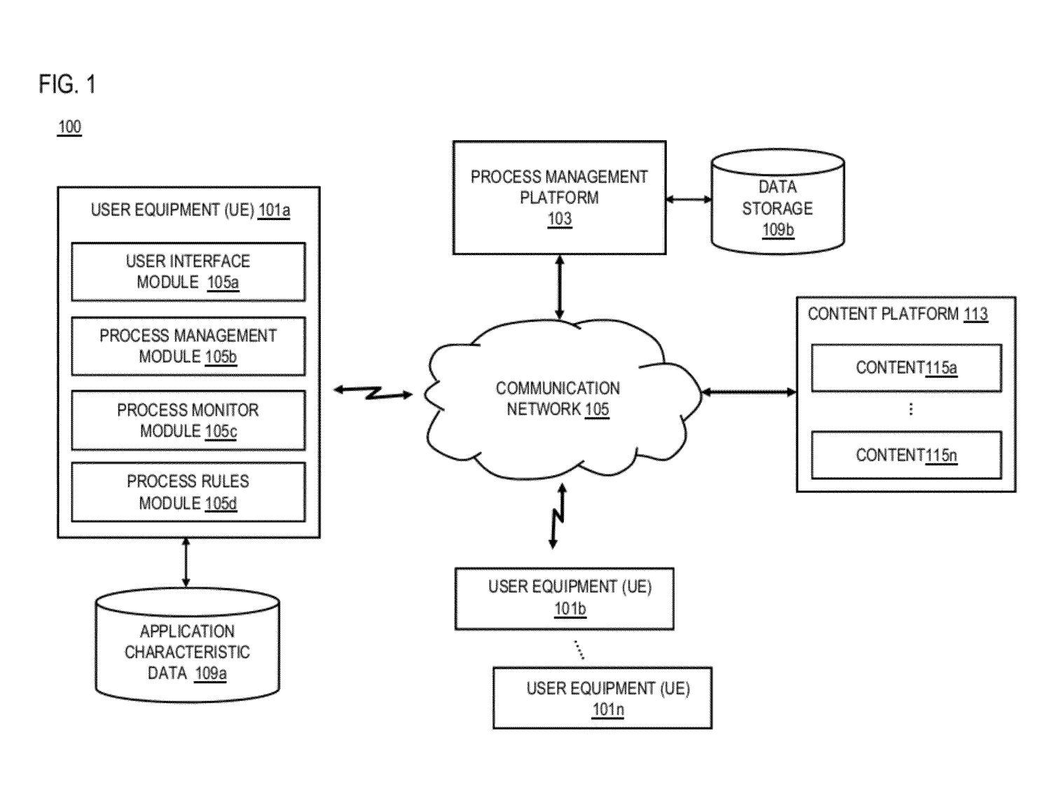

FIG. 1 is a diagram of a system capable of pre-initializing application rendering processes, according to one embodiment. By way of example, the system 100 enables user devices, namely user equipment (UEs) 101a-101n (also collectively referred to as UEs 101), to optimize the execution and allocation of rendering processes within the UEs 101a-101n by pre-initializing at least partially one or more of the rendering processes. Today's UEs 101 are used to perform various processing tasks, including connecting to the Web to access a growing variety of web-based services, functions, content and the like. Typically, UEs 101a-101n feature browsers or web applications executing within the browsers that enable the download or execution of content by way of a communication network 105, thus enabling the performance of the processing tasks described above and much more. In certain embodiments, “content” refers to any information or data that may be viewed, executed, manipulated or rendered by a browser or web portal application for fulfilling specific tasks. Content may include video, audio, internet data, data files, streaming media, object code, images, contextual and semantic data, textual data, etc. Generally, the content 115a-115n in its myriad forms is provided to users over the communication network 105 by way of a content platform 113 (e.g., a specific website, internet server, file server).

The browser or web application facilitates the viewing, execution, manipulation or rendering of content by managing the various operating system (OS) and/or browser processes (e.g., rendering processes) that are created when the user performs various browsing actions. These actions may include, by way of example, typing a URL to access a specific content source location, clicking an embedded link for invoking an e-mail editor to send an e-mail, pressing the back or forward button to recall or advance content, manipulating the buttons of a web or script based streaming media player, etc. In one embodiment, each of the web applications are executed and rendered to the browser via one or more “rendering processes,” which in certain embodiments, pertains to an instance of execution of one or more instructions of a computing device or application thereof. As used herein, the term “rendering process” includes at least in part a rendering engine, a scripting engine (e.g., a JavaScript engine), and an associated execution context.

Depending on the operating system (OS), a process may be made up of multiple threads of execution that execute instructions to be carried out concurrently. With respect to a browser, web application or the like, concurrently open websites are typically presented as tabs, allowing the user to easily toggle between varying content 115a-115n within the same browser window. The browser application may decide to run each tab in its own OS process, run all tabs in a single OS process, etc.

Creating a new process for each website or content source increases robustness because the OS takes care of isolating respective processes. By isolating processes, when one process crashes it does not affect the other processes in operation concurrently. However, as a consequence, each new process consumes resources, especially memory, of the UEs 101a-101n. This is especially problematic for web applications because a large part of the browser application code needs to be duplicated for each process allocated by the OS. The overhead and resource taxation incurred by a typical UE 101a-101n for executing web-technologies on a process per application basis can be in the range of 3-7 MB. Some browser applications may even consume up to 20 MB of RAM just by being launched, before any URL has been specified and loaded. Hence, this drain on resources is especially problematic for desktop computers and critical for mobile devices and other portable wireless communication devices having smaller resource capacity. An alternative approach is to run several applications for enabling content 115a-115n in a single process, which leads to less overhead per application. However, an application crash may result in process termination, in turn effectively terminating all the other applications in the same process as well.

As previously noted, web applications, even when loaded from a local offline cache, have significantly longer startup times than native applications, due to, for instance, the need to load, parse, and/or interpret the applications' code (e.g., HyperText Markup Language (HTML) code, scripting code (e.g., JavaScript code), cascading style sheet (CSS) code, and/or other related code. Also, if a web application is to be executed in a separate rendering process, a new rendering process may need to be started. Moreover, if just-in-time (JIT) compilation is used, compiling the JavaScript code can increase the processing and/or other resource load of the executing device and potentially delay the startup further. Furthermore, some code interpretation frameworks (e.g., JavaScript frameworks) employ dynamic loading which means that the application code is first loaded and parsed only partially, then executed. At that point, additional application code is loaded and parsed and executed; the process is then further repeated. This kind of code architecture can slow the startup times even further.

To address this problem, system 100 of FIG. 1 introduces the capability to pre-initialize one or more rendering processes to support execution or one or more web applications. More specifically, the system 100 uses separate rendering processes to support execution instances of one or more web applications. In one embodiment, by using separate rendering processes, the system 100 enables the creation of a pool of pre-initialized processes on standby that speed up the startup time when requests to execute the web applications are received. In one embodiment, the rendering processes for the most commonly used applications and/or scripting libraries (e.g., JavaScript libraries) may be pre-initialized.

In some embodiments, a rendering process may be fully initialized (e.g., pre-initializing including preloading an entire web application), partly initialized (e.g., some of the code, libraries, resources, etc. of the web application is pre-initialized or preloaded), or uninitialized (e.g., rendering process is ready to load an application but no parts have been loaded yet).

In another embodiment, the rendering processes may be pre-initialized with respect to a particular (e.g., commonly used) application. In other words, the pre-initialized rendering process can only be used to execute or support an execution instance of the particular application. In addition or alternatively, the rendering processes may be pre-initialized with respect to one or more libraries (e.g., JavaScript libraries), resources (e.g., CSS files), data object definitions, or a combination thereof, whereby the pre-initialized rendering processes support any applications that use any of the pre-initialized libraries, resources, and/or data object definitions.

In another embodiment, the pre-initialization of the rendering processes can be customized for known applications or applications that are made aware of the pre-initialization. For example, the developers of applications that are aware of the pre-initialization can specify initialization parameters (e.g., specific libraries, resources, etc. to preload) and/or rules (e.g., pre-initialization is based on detecting specific contexts or conditions).

In yet another embodiment, the number of rendering processes on standby (e.g., waiting on a request to execute an application) and the degree of pre-initialization (e.g., full, partial, or none) can be varied to control the amount of available resources (e.g., RAM memory, processing cycles, network bandwidth, etc.). In other words, the pool and/or composition of the pre-initialized rendering processes can have a “variable footprint” (e.g., resource footprint) within the device.

As shown in FIG. 1, the system 100 comprises a user equipment (UE) 101 having connectivity to a process management platform 103 via a communication network 105. In one embodiment, the process management platform 103 performs all or part of the pre-initialization processes of the various example embodiments described herein. In addition or alternatively, the UE 101 may include one or more modules (e.g., a user interface module 105a, a process management module 105b, a process monitor module 105c, and/or a process rules module 105d) to perform all or part of the processes to pre-initialize application rendering processes.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

As noted above, in one embodiment, the UEs 101a-101n include one or more components for pre-initializing application rendering processes to support executing applications. By way of example, the components operate to enable pre-initialization processes of the UE 101 based on application characteristic data 109a to specify whether and how to create a pool of pre-initialized rendering processes to reduce application startup times. Still further, various components of the UE 101 coordinate the sharing of resource usage data with a process management platform 103 and receives feedback from the platform 103 that enables it to pre-initialize rendering processes based on analysis of resource information. The resource information specifies data pertaining to the usage of various resources (e.g., RAM, processing resources, bandwidth, etc.) by the one or more UEs 101a-101n. For the one or more components of the UE 101 (e.g., the user interface module 105a, the process management module 105b, the process monitor module 105c and the rules update module 105d), it is contemplated their functions may be combined in one or more components or performed by other components of equivalent functionality. In addition, the components may be local to the respective UEs 101a-101n or available remotely over the communication network 105 (e.g., cloud resources).

In certain embodiments, the user interface module 105a enables a web application to be rendered to a display of a given UE 101a-101n for enabling a user to access a content platform 113 or other functions of the web application. By way of example, the content platform 113 may be any source available by way of a network or communication channel for generating, maintaining or publishing content 115a-115n. The user interface module 105a, by way of example, enables presentation and navigation of content made available by the content platform 113. Navigation and presentation of content is facilitated by way of a uniform resource locator (URL) entry field or through the accessing of various embedded links. In addition, the user interface module 105a is configured to enable execution of content as various web applications (e.g., the starting and stopping of web applications), scripts, executable objects and the like for supporting various types of web-based or network based interactions. To enable concurrent access to content, the browser or web portal application supported by the user interface module 105a may provide for the multiple frames, windows or tabs to be presented to the UE 101a-101n display accordingly, relative to particular device configurations, modes of operation, screen size availability, etc. As will be discussed, such characteristics, pertaining to both the device capabilities and/or the application being executed may be considered and accounted for by a process management platform 103 in customizing the pre-initialization of one or more rendering processes for executing one or more applications at the respective UE 101.

In one embodiment, a process management module 105b decides which rendering processes of which applications (e.g., web applications) are to be pre-initialized based on the determined characteristics of the application or the UE 101 upon which it runs. By way of example, the characteristics include one or more security properties, one or more authentication properties, one or more permissions, frequency of use, resources used, importance, priority, or a combination thereof. In one embodiment, the characteristics are identified and provided by one or more servers that host the respective applications. In addition or alternatively, the characteristics may be determined at the UE 101 based on, for instance, the resources, permissions, etc. requested by the applications.

By way of example, the process management module 105b operates deterministically, taking the information from the user interface module 105a, application characteristic data 109a and the process monitor module 105c into account for executing process pre-initialization decisions. For example, a web application operable in connection with the user interface module 105a may provide application URL and notification about application lifecycle events (e.g., application start, stop or suspend) to the process management module 105b as input parameters into pre-initialization decisions. For instance, the stopping or closing of an application may signal to the process management module 105b that additional resources (e.g., RAM) may be available to support pre-initialization of additional rendering processes. Similarly, executing or starting an application may indicate a reduction in the amount of resources, which may cause the process management module 105b to kill one or more pre-initialized rendering processes to make more resources available.

In one use case, when a user first navigates to an unknown website, corresponding to the starting of an unknown web application, application characteristic data 109a relative to this site (application) may not yet exist and a designated default action as specified in the rule data 109a can be taken. An exemplary default action may be to pre-initialize rendering processes for the new application if there are available resources. Another default action may be to ask the user to manually specify the initialization parameters and/or rules associated with the application. Yet another default action may be to retrieve or otherwise determine the pre-initialization parameters and/or rules associated with the application by, for instance, the application developer, service provider, network operator, device manufacturer, etc.

In one embodiment, the process monitor module 105c gathers information about the state of the UE 101 operating system and running web applications. System and application state, interaction and functional information is immediately available to the process management module 105b; the process management module 105b including various functions for interacting with the OS, interacting with the application programming interface (API), accessing execution threads, etc. By way of example, system information acquired and interpreted by the process monitor module 105c includes:
Data indicative of how much system resources, such as free RAM memory, are currently available;
Data indicative of how many processes are currently pre-initialized and how much RAM memory each pre-initialized process is currently consuming.

In addition to the system related information, the process monitor module 105c monitors and gathers information about any running web applications, including:
Data specifying how frequently the application is used (e.g., as received from the web application via the process management module 105b);
Data indicative of how much resources the web application has consumed (e.g., based on first time execution and possibly subsequent executions)
   Upon collecting the data pertaining to the application in question, the process monitor module 105c provides the data to the process management platform 103. In addition, the process monitor module 105c provides the data regarding the UE 101 upon which the application was run. Data provided may also include metadata for specifying various details regarding the application, including application name, version or build numbers, execution or error codes, process sequences, accessed libraries, accessed resources, etc. Likewise, metadata associated with the UE or operating system may include OS version numbers, hardware builds or status information, processor or controller details, model numbers, etc. Any data useful for characterizing the application or device (e.g., UE 101) or for detailing the resource usage of the device or application may be gathered and subsequently reported by the process monitor module 105c.

It is noted that the process monitor module 105c is configured to monitor, intercept or interpret any information useful for specifying the current and/or historical operational, functional or statistical state of the UE 101 or applications running thereon. Still further, it is noted that to the extent multiple UE 101a-101n are configured with a process monitor module 105c, the process management platform 103 is able to gather a wide set of data regarding the various operations and interactions of differing devices and applications. In one embodiment, this information is used for continually developing refined process pre-initialization rules or policies that are responsive to real world conditions and for enabling enhanced pre-initialization decisions to be made.

In one embodiment, a rules update module 105d updates both the process pre-initialization data maintained by the UE 101a and that maintained by the process management platform 103 based on the information collected by the process monitor module 105c. By way of example, the rules update module 105d is notified if new application characteristic data 109a is available at the process management platform 103. The update process, wherein the process management platform 103 provides process pre-initialization rules (e.g., as part of application characteristic data 109a) to the UE 101a, may be performed at a various frequencies or as directed. It is noted that in certain implementations, the communication between the UE 101 and process management platform 103 is piggybacked during other information exchanges that occur between them.

Communication is facilitated between the UE 101, process management platform 103, content platform 113 via the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the process management platform 103 and one or more of the modules 105a-105d interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

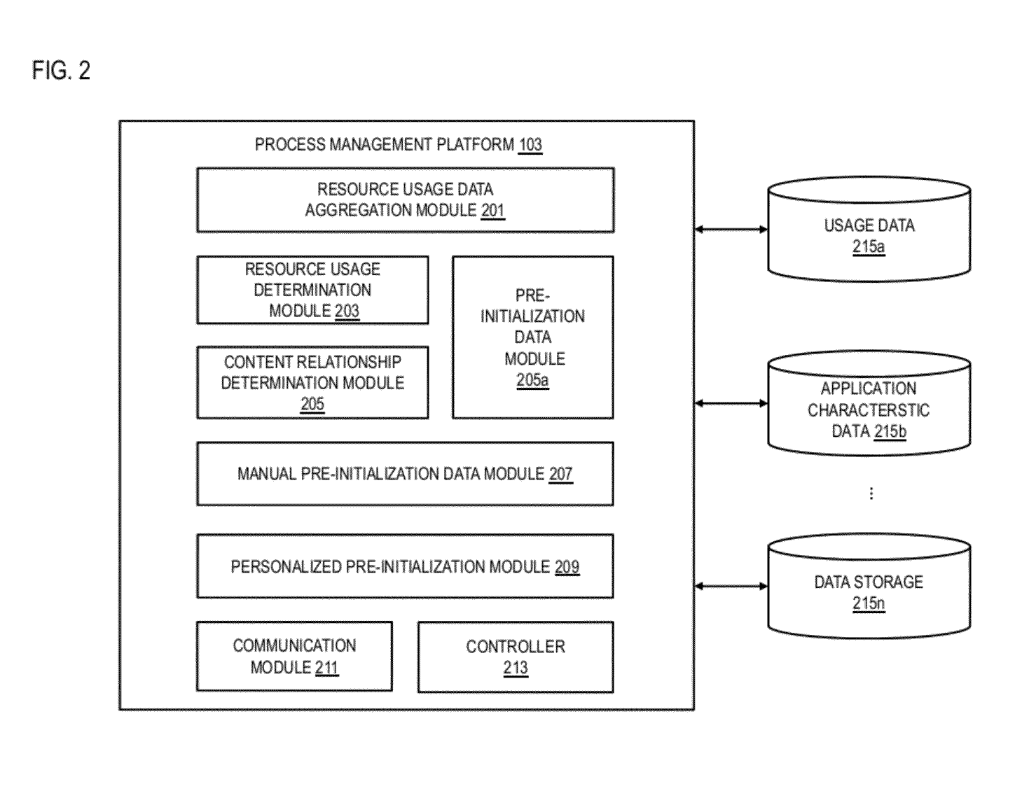

FIG. 2 is a diagram of a process management platform, according to one embodiment. By way of example, the process management platform 103 includes one or more components for pre-initializing application rendering processes. It is contemplated that the functions of these components may be combined in one or more components or performed by other components of equivalent functionality. In one embodiment, the process management platform 103 includes a resource usage data aggregation module 201, a resource usage determination module 203, a content relationship determination module 205, a pre-initialization data module 205a, a manual pre-initialization data module 207, a personalized pre-initialization module 209, a communication module 211 and a controller 213. The controller 213 oversees tasks performed by the components of the system, including facilitating data exchange and storage of context information through use of various data storage devices 109a-109n and regulation of its own interactions with the other components 203-211.

In one embodiment, the resource usage data aggregation module 201 receives information about UEs 101a-101n and/or associated web applications. This information is relayed to the resource usage data aggregation module 201 by respective process monitor modules 105c of UEs 101a-101n, and includes information regarding the functional, operation or statistical state of the UE 101 or web applications operable thereon. As mentioned previously, the process management platform 103, via the resource usage data aggregation module 201, can interact with process monitor modules 105c of respective UEs 101a-101n on a periodic basis (e.g., once per day) for receiving such data. The interaction can also be performed during the course of normal communication between the process management platform 103 and the process monitor modules 105c as a “piggyback” process. By way of example, usage data is piggybacked or packaged along with data exchanged with the process management platform 103 during a routine diagnostic, regular system status check or other communication session. Upon receipt, the resource usage data aggregation module 201 can compile the data in a usage data database 215a or other data storage 215n, where current information can be aggregated with historical information of the same type.

It is noted that the data aggregated by module 201 may be organized for historical recollection, real-time analysis or other means of interpretation for determining specific usage and operational characteristics of differing UEs 101 and/or applications. In one embodiment, this operation is performed by the resource usage determination module 203. By way of example, the resource usage determination module 203 analyzes the usage data 215a and determines the usage trends, commonalities and other characteristics that define the different UEs 101a-101n and web applications. By way of example, the resource usage determination module 203 processes the data in accordance with a developed data model that attempts to characterize the behavior of a given web application relative to a specific moment of use, may employ various statistics or metrics for specifying the usage of differing UEs, etc. It is noted that, once the number of participating UEs 101 has grown over some threshold, there will be information about the vast majority of used web applications. As such, the resource usage determination module 203 may rely on this collected data for characterizing or otherwise determining how resources are used by respective UEs 101a-101n or applications. This application characteristic information can then be used for determining conditions, parameters, etc. for pre-initializing one or more rendering processes associated with the applications.

In one embodiment, a content relationship determination module 205 determines the relationship between varying types of content as accessed from a particular content platform 113 via a web application of a given UE 101. By way of example, the content relationship determination module 205 may be configured to browse the content 115a-115n as accessed by a given application in a methodical, automated manner or in an orderly fashion. A technique for analyzing the content by module 205 may include URL normalization or canonicalization, which refers to the process of modifying and standardizing a URL for various content in a consistent manner (e.g., to determine content source commonality). Under this approach, it is possible for the module 205 to determine if sites featuring content 115a-115n that appears to be non-related based on their domain (e.g. www.content_source.fi and www.content_source.com) are related to the same organization/individual, which in turn, makes them related. Another technique employed by the content relationship determination module 205 may include path ascendency analysis, wherein the commonality between various links between content is analyzed; or content revisitation analysis, where the amount of time content is actively browsed, its relevancy or the frequency of access of content 115 by the application is analyzed. Still further, the content relationship determination module 205 allows content relative to various web applications to be categorized based on various criteria, such as importance, origin, relational affinity, complexity and required permissions. It is noted that the content relationship determination module 205 may be employed or implemented using known web crawler architectures. Moreover, it is noted the content relationship determination module 205 may be implemented or accessed as a third party web tool for performing automated content crawling.

The content relationship determination module 205 can provide additional data regarding the characteristics, uses, classifications, etc. of the various UEs 101 and web applications to assist in the pre-initialization process. By way of example, determining the relationship between different sets of content 115a-115n may be used for further recognizing application and/or UE 101 usage respective to the execution or access of different content. This process may be performed in conjunction with the resource usage determination module 203. Having generated usage data 215a and determined the relationship between respective content 115a-115n, this information can be compiled by a pre-initialization data module 205a of the process management platform 103 into application characteristic data 215b for use in determining whether and how to pre-initialize one or more rendering processes corresponding to one or more respective applications. In certain instances, the pre-initialization data module 205a may generate or adapt the data 215b based on one or more data models or schemas, such as maintained in storage 215n.

In one embodiment, a manual pre-initialization data module 207 also enables the generation or adaptation of usage data 215a. By way of example, the manual pre-initialization data module 207 enables the input of usage data 215a and/or application characteristics data 215b that cannot be or is not otherwise automatically determined by the resource usage determination module 203 or informed by the content relationship determination module 205. For example, a manual pre-initialization rule may call for URLs of core applications (as designated by a user) to be listed, so that the UE 101 can pre-initialize rendering processes for core applications regardless of other factors used to determine pre-initialization. As another example, manually entered pre-initialization parameters and/or rules may be provided for enabling pre-initialization of at least a portion of certain rendering processes on a per site or a per content basis. It is noted the process management platform 103 accommodates both manual and automated generation of usage data 215a, application characteristic data 215b, pre-initialization parameters and/or rules (e.g., which processes to pre-initialize, when to pre-initialize, to what extent to pre-initialize, under what contexts to pre-initialize, under what resource availability conditions to pre-initialize, etc.), and the like.

In one embodiment, a personalized pre-initialization module 209 combines the information generated by the above described modules 203-207 to produce user-specific customized pre-initialization parameters and/or rules. In one embodiment, such user-specific pre-initialization parameters and/or rules are based, at least in part, on, for instance, information about major web-sites and sites visited by the user recently. In another embodiment, the personalized pre-initialization module 209 can make implicit determinations on what applications are favored by a particular user and then mark the identified applications for pre-initialization. For example, the personalized pre-initialization module 209 may determine whether to pre-initialize rendering processes associated with particular applications by determining: (1) whether the user has created a link or shortcut to the application on a home screen or browser of the UE 101; (2) whether the user has rated a particular application; (3) whether the user has recommended an application to other users; and the like. It is noted that while the above described processes are presented with respect to the activities of the process management platform 103, certain implementations contemplate execution of these processes at both the UE 101 and process management platform 103 or just the UE 101.

In one embodiment, the various protocols, data sharing techniques and the like required for enabling collaborative execution between UEs 101a-101n over the communication network is provided by way of a communication module 211. As the various UEs 101a-101n may feature different communication means, the communication module 211 enables the process management platform 103 to adapt to these needs respective to the required protocols of the communication network 105. In addition, the communication module 211 may appropriately package data for receipt by a respective UE 101a-101n. By way of example, the communication module 211 packages the application characteristic data 215b as generated by the pre-initialization data module 205a, the manual pre-initialization data module 207, and/or the personalized pre-initialization module 209 for transmission to respective UEs 101.

It is noted that application characteristic data 215b are generated or maintained by respective UE 101a-101n as well as the process management platform 103. In one embodiment, in an effort to maintain a level of synchronicity of the application characteristics data 215b data between the various UE 101a-101n and process management platform 103, an update process is performed as described before. As a general update mechanism, application characteristic data 215b maintained by the process management platform 103 may be downloaded by UE 101a-101n for inclusion with its current data set 109b. By way of this approach, the dataset 109b maintained by a single UE 101 may account for and be informed of application characteristic data for all UEs 101a-101n configured over the network 105. This makes for a more robust application characteristic dataset for execution at respective UEs 101. It is noted therefore, that pre-initialization of application rendering processes may be performed differently in each UE 101a-101n due to variations in user preferences and application use while also accounting for known operating conditions of various UEs 101.

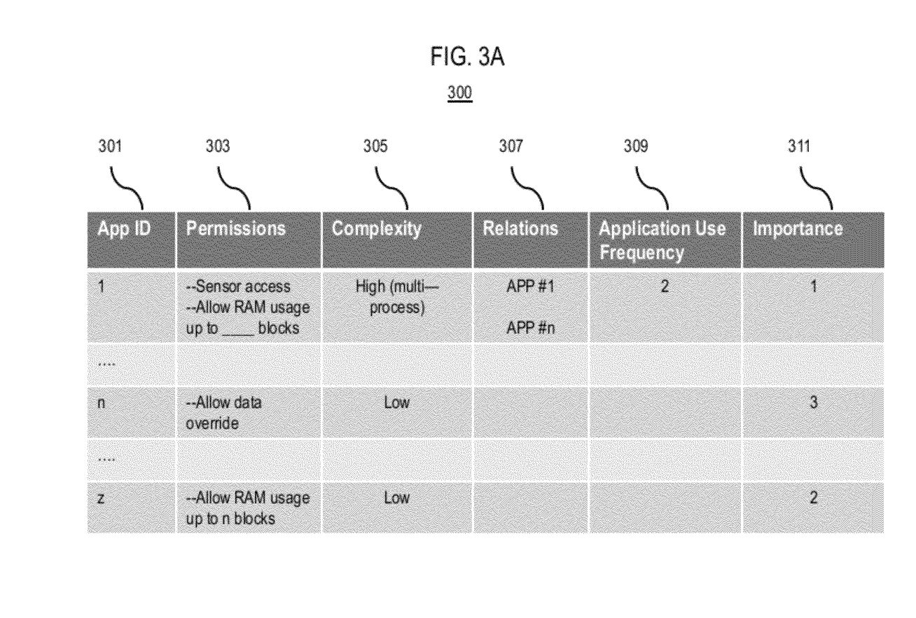

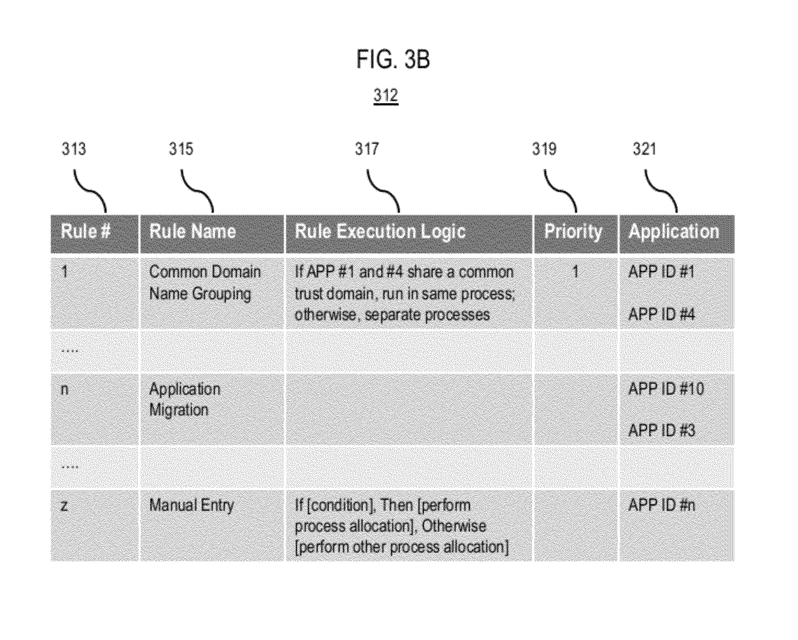

In another embodiment, as a further means of ensuring proper synchronization of application characteristic data among respective UEs 101 and the process management platform 103, the application characteristic data can be generated and defined according to a common data framework. FIG. 3A is a diagram of a data structure representative of application characteristic data for enabling pre-initialization of application rendering processes, according to one embodiment. As mentioned, the application characteristic data 109a is stored to the UE 101 and updated as necessary, using application characteristic data maintained by the process management platform 103 (e.g., in the application characteristic database 215b). This update process is facilitated by the process management module 105b and process monitor module 105c as described. Data structure 300 ensures the integrity of the dataset maintained at a respective client (e.g., UE 101) while enabling the overriding of certain data received from the server (e.g., process management platform 103).

By way of example, data structure 300 may include an application identifier 301 for specifying a particular application (e.g., application URL), permissions settings 303 as required by the application, a complexity indicator 305 or ranking for specifying the extent of processing complexity required by the application, a relational indicator 307 for specifying other applications of the UE that are related to the specified application for enabling execution of tasks and/or processes, an application usage frequency 309 for indicating how often the application is used and an application importance 311 for ranking the importance of the application relative to other related applications or processes at hand to be performed. Other data items may also be defined by the data structure 300 accordingly such as additional pre-initialization parameters and/or rules to direct how rendering processes for specific applications are to be pre-initialized.

In one embodiment, the permissions settings data 303 is used to indicate and determine whether certain content (e.g., specific web site) is allowed to access certain data or functionality (e.g., GPS sensor, camera, file system) on the UE 101. Generally, this data is user-specific, as one UE 101 may allow a site “www.somesite.com” to access its GPS sensor data while another UE 101 may be configured to deny this capability. It is noted that website permissions settings may be used to set the permissions of a rendering process when the process management module 105b pre-initializes or preloads all or part of the rendering process.

The complexity indicator 305 may be established based on numerous criteria, including an average application loading, processing or completion time; typical resource usage required for the application and other factors. This data may be informed by the process management platform 103 which compiles data for a plurality of UE 101a-101n.

Of the various application characteristics defined by the data structure 300, permissions settings 303, complexity indicator 305 and the relational indicator 307 may be overridden by the process management platform 103. This is because data elements 303, 305 and 307 are common for (or generalized with respect to) all UE 101a-101n configured at a given time to the process management platform 103. Hence, during the application characteristic data update process, a respective UE 101 may update this data with that provided by the process management platform 103 accordingly. However, usage frequency 309 and application ranking 311 are user/UE 101 specific criteria that pertain only to a single UE 101. Consequently, during the update process this data is not overridden by the process management platform 103. It is noted that in addition to the above described application characteristic data 109a of data structure 300, some characteristics that affect application process pre-initialization decisions need not be stored. Rather, they are runtime characteristics that are observed by the process management module 105b or process monitor module 105c, e.g., current RAM availability.

In one embodiment, the application characteristics may include: (1) one or more security properties (e.g., the security features that are used by the application such as type of encryption, public key infrastructure, and the like); (2) one or more authentication properties (e.g., the policies for authenticating access to the application or its functions such as username/passwords, biometric identification, etc.); (3) one or more permissions (e.g., the resources of the device or other components to which the application has or seeks access); (4) frequency of use (e.g., how often is the application executed and/or used at the device); (5) importance (e.g., does the application relate to core functions of the device); (6) pre-initialization parameter and/rules; or a combination thereof.

FIG. 3B is a diagram of a data structure representative of rules for enabling pre-initialization of application rendering processes, according to one embodiment. In one embodiment, the pre-initialization logic operates on data representative of pre-initialization rules and related parameters to be applied by a UE 101 based on the compiled application characteristic data of data structure 300. By way of example, data structure 312 may include a rule number 313 for referencing a specific pre-initialization rule, a rule name that provides a general description of the rule 315 to be applied, associated rule execution logic 317 for describing the logical rules and executions to be applied given a set of determined conditions, a priority setting 319 for specifying the level of importance of a rule relative to others, and application data 321 for indicating the applications to be impacted through execution of the pre-initialization rules. Other data items may also be defined by the data structure 312 accordingly.

The priority setting of a given rule is based generally upon a wide set of usage factors, content relationship factors and other data as compiled and/or generated by the process management platform 103 for a plurality of UE 101a-101n. As an example, when a given UE 101 is associated with a particular wireless communication service provider (that maintains a process management platform 103), the priority setting is assigned according to the determined usage, relationship and other characteristics of all UEs 101 associated with the provider. Hence, the process management platform 103 sets the priority 319, via the pre-initialization data module 205a, so as to determine process pre-initialization approaches that are best suited for the various UEs 101 configured for communication with the process management platform 103. It is noted that, in one embodiment, execution of a pre-initialization rule by the process management module 105b is performed in consideration of the application importance ranking 311 as assigned to a specific application.

It is further noted that application data 321 indicates one or more application identifiers (IDs) that are to be associated with a specific pre-initialization rule. As indicated with respect to FIG. 3A, each application ID is also defined according to various other characteristics pertaining to its use, execution and relevancy with respect to a given UE 101. By way of this commonality, application characteristic data 300 may be associated with specific process pre-initialization logic data 312 to be applied for the application. It is noted that system 100 enables the pre-initialization of rendering processes within UE 101 on the basis of individual and/or real-time device conditions and needs, and also best practices for devices in general.

In one embodiment, the data structure 312 may be implemented according to various known data formats and conventions. Likewise, the execution logic 317 as specified within the data structure may be implemented in accordance with any programming language or syntax that facilitates web-based execution. This includes extensible markup language (XML), JavaScript, various .NET protocols (e.g., ASP.NET), Simple Object Access Protocol (SOAP) and the like. As an example, the rule execution logic 317 is conforms to a general expression wherein IF a condition is determined (e.g., two applications share a common trust domain), THEN a specific logical operation is performed (e.g., pre-initialize one or more processes that can support both applications), OTHERWISE perform a different logical operation (e.g., pre-initialize rendering processes separately for each of the two applications).

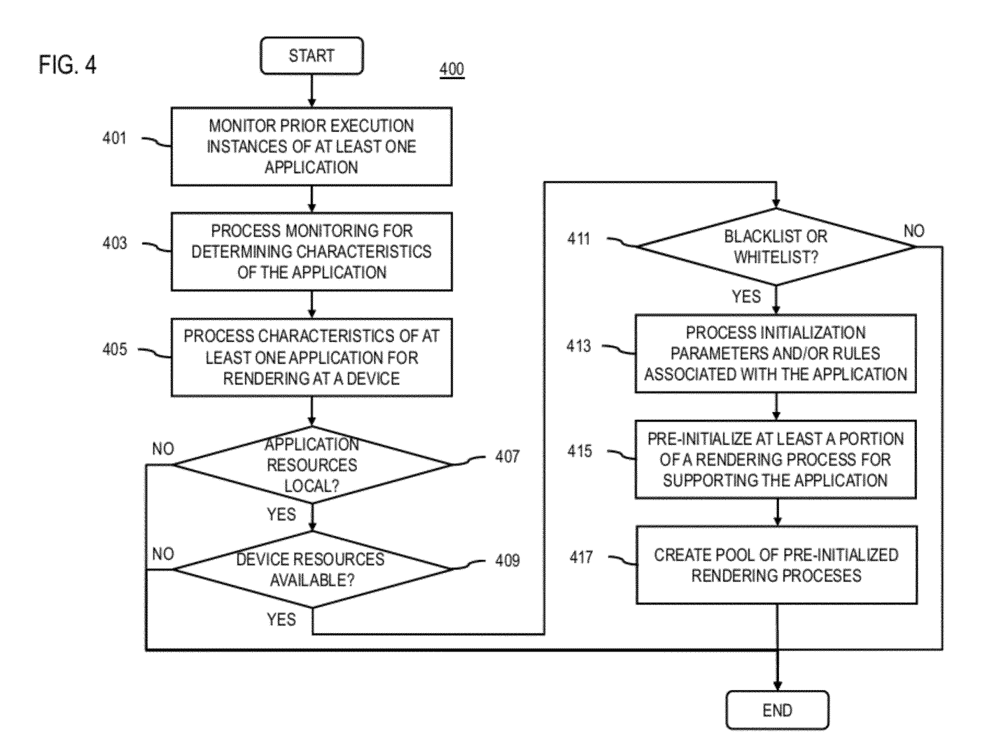

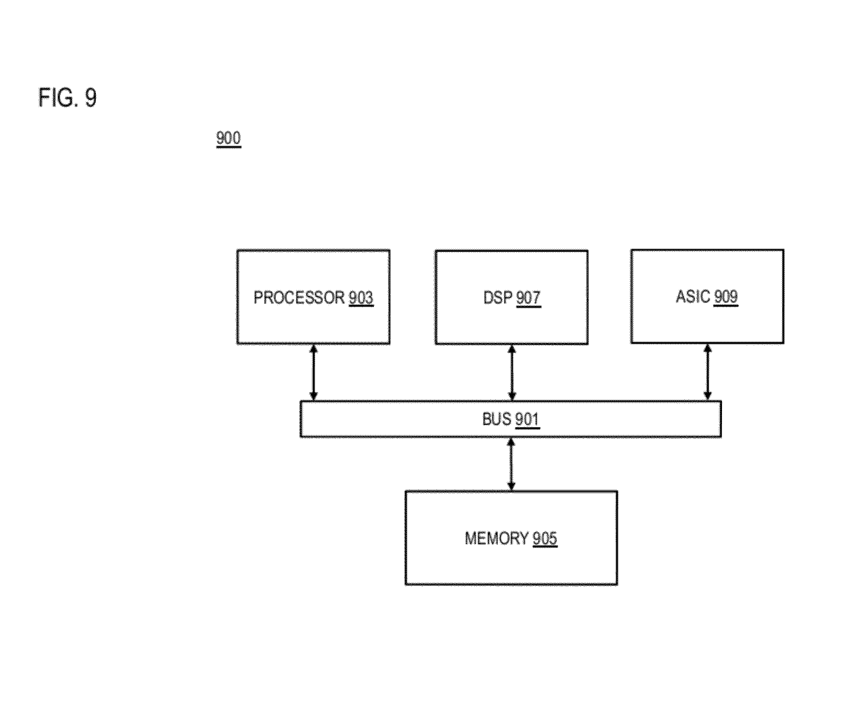

FIG. 4 is a flowchart of a process for pre-initializing application rendering processes, according to one embodiment. In one embodiment, the process management platform 103 performs the process 400 and is implemented in, for instance, a chip set including a processor and a memory as shown in FIG. 9. In addition or alternatively, one or more of the modules 105a-105d of the UE 101 may perform all or a portion of the process 400.

At step 401, the process management platform 103 determines to cause, at least in part, monitoring of one or more execution instances of the at least one application. The process management platform 103 then processes and/or facilitates a processing of the monitoring for determining the one or more characteristics of the monitored applications (step 403). In one embodiment, the one or more characteristics are used to direct pre-initialization of one or more rendering processes associated with the monitored applications or other related applications. By way of example, the one or more characteristics include, at least in part, a use pattern, a frequency of use, a priority, a classification, a context, a preference, or a combination thereof of the at least one web application (as previously described).

Next, the process management platform 103 processes and/or facilitates a processing of the one or more characteristics of at least one application for rendering at a device (step 405). In one embodiment, the processing includes determining whether one or more libraries, one or more resources, or a combination thereof of the at least one application are available locally, remotely, or a combination thereof (step 407). In some embodiments, the process management platform 103 is configured to pre-initialize only those portions of the at least one application (e.g., libraries, resources, etc.) that are available locally. In this way, the process management platform can reduce potential network bandwidth and other resource consumption associated with retrieving resources over the communication network 105. In other embodiments, for example where bandwidth and resources are less restricted, the process management platform 103 may proceed with the pre-initialization process even when some or all of the portions of the at least one application is only available remotely over the communication network 105 (e.g., available at a remote server or content provider).

At step 409, the process management platform 103 determines whether there are resources (e.g., RAM, processing, bandwidth, etc.) available at the executing UE 101 to support the pre-initialization of the one or more rendering processes of the at least one application. In one embodiment, even if the resources and the characteristics indicate that a particular rendering process should be pre-initialized, the process management platform 103 may consult a pre-initialization blacklist and/or whitelist to determine whether to proceed with pre-initialization (step 411). By way of example, the pre-initialization blacklist provides a list of applications that should not be pre-initialized and the whitelist provides a list of applications that should always be pre-initialized. It is contemplated that the blacklist and whitelist can be used individually and/or in combination to determine whether to proceed with pre-initialization of the one or more rendering processes. For example, when a whitelist is used individually, only applications on the whitelist would be candidates for pre-initialization. For another example, when a blacklist is used individually, only applications not on the blacklist would be candidates for pre-initialization.

At step 413, if the decision is to proceed with pre-initialization, the process management platform 103 processes and/or facilitates a processing of one or more initialization parameters, one or more initialization rules, or a combination thereof associated with the at least one application. The process management platform 103 then causes, at least in part, a pre-initialization of at least a portion of at least one rendering process at the device for supporting the at least one application based, at least in part, the one or more characteristics, the one or more initialization parameters, the one or more initialization rules, or a combination thereof (step 415). In one embodiment, pre-initializing a rendering process includes preloading into the at least one rendering process of one or more libraries, one or more resources, or a combination thereof associated with the at least one application. It is noted that the initialization or pre-initialization of the one or more rendering processes occurs or is otherwise performed prior to receiving a request to initiate an execution instance of the at least one application.

In one embodiment, the process management platform 103 can create and maintain a pool pre-initialized rendering processes on standby in anticipation of requests to execute any corresponding application (step 417). In some embodiments, the extent and composition of the pool is based on available device resources, application priority, application characteristics, etc.

As described previously, a rendering process contains or includes the rendering engine, a scripting engine or code interpretation engine (e.g., a JavaScript engine), and an execution context. By way of example with respect to JavaScript, a JavaScript execution context results from operation of the JavaScript engine on the application code. Thus, if a JavaScript library is loaded by a browser, the library becomes part of the JavaScript execution context in the rendering process. By preloading the libraries, resources (e.g., CSS files), object definitions, and other application related components, the rendering processes can be pre-initialized with one or more portions or components of the application, thereby reducing potential application startup time when a request to execute the application is received.

It is noted that while some libraries (e.g., JavaScript libraries) utilize dynamic loading with safeguards against loading a library twice, the same has not been historically true for HTML applications in general. As a result, in one embodiment, the process management platform 103 extends the browser with a mechanism to prevent a JavaScript library from being loaded again if the library has already been preloaded into the execution context of the rendering process during pre-initialization. In another embodiment, to make the mechanism transparent to the application, a dummy (or empty) file can be returned so that a command to execute the application (e.g., a JavaScript eval( ) command) can still function as normal.

In one embodiment, the process management platform 103 may perform a full pre-initialization or a partial pre-initialization of the rendering process. For example, full pre-initialization preloads all components (e.g., libraries, scripts, resources, etc.) into the rendering process to remain on standby for a request to execute.

The process for partial pre-initialization is more complicated than full pre-initialization. In one embodiment, to perform a partial pre-initialization, the process management platform 103 opens a generated page (e.g., a preload page) in the rendering process which loads the specified components (e.g., JavaScript code, JavaScript libraries, CSS files, etc.), and then loads the actual application startup page into the rendering process when the user requests that application to be started. Normally, navigating to a new page re-initializes, for instance, the JavaScript and CSS context. In one embodiment, the re-initialization can be avoided by instead downloading the new (application) page from within the context of the old (preload) page using, for instance, an XHR (Extensible Markup Language (XML) Hypertext Transfer Protocol (HTTP) Request) and replacing the preload page's HTML with that of the new application page. Normally, the preload page must be in the same domain as the actual application startup page. For example, XHR requests can normally not cross domains. In one embodiment, the process management platform 103 sets the domain of the preload page to be the same as the application startup page.

In one embodiment, the JavaScript and CSS components used for partial pre-initialization or preloading can be determined by monitoring or tracing the execution of a web application during prior execution instances. In some embodiments, the order in which files are placed into the execution context of the rendering process is significant and should be adhered to during the pre-initialization process.

In one embodiment, the rendering processes pre-initialized or preloaded with common JavaScript libraries can be used to speed up the startup time of any application that uses those libraries (note that web applications from different providers typically do not share JavaScript libraries, but applications from the same provider often do so). Even if the application does not need all the preloaded libraries, the pre-initialized rendering process can typically still be used because the unnecessary libraries only introduce a RAM or other resource overhead. In some cases, the unnecessary library or libraries may redefine standard JavaScript objects in a way that adversely affects the application. In this case, another rendering process may be used or the unnecessary libraries may be unloaded or otherwise disabled.

In some cases, it is possible that the method for partial preloading is not appropriate for a particular application. For instance, if an application verifies in some way the loaded JavaScript files, then returning a dummy file like described above may fail. Therefore, whitelisting or blacklisting of applications may be needed as discussed above. For example, applications that are not on a partial preload whitelist (e.g., wherein the whitelist includes applications which are known to work with partial pre-initialization) may be restricted to use only full pre-initialization.

In another example of using a partial preload whitelist or blacklist, some applications might have problems with the long period between application load and application use. For example, an application might feature automatic login to a service on startup, but also log out after a certain period of inactivity. If this becomes a significant problem, whitelisting or blacklisting of applications may be needed also for full pre-initialization.

In one embodiment, application developers who are aware of the pre-initialization capabilities discussed herein may manually create preload pages for known applications to specifically define pre-initialization steps, parameters, rules, etc. associated with a particular application. In addition, applications may also define their own preload or pre-initialization pages by, for instance, using a link tag.

In one embodiment, pre-initialization or preloading is limited to application components that can be found from local cache, otherwise their availability (and access cost) cannot be guaranteed. One way of ensuring this is to, for instance, only apply pre-initialization to web applications which have a HTML5 cache manifest. In other embodiments, a separate application cache (similar to HTML5 application caches) can be created for the preloaded files to ensure their availability. In cases, wherein availability and/or access cost is not an issue, pre-initialization can be expanded to include both local and remote components of an application.

It is noted that since the user typically does not run two instances of the same application simultaneously, there typically should not be a standby process pre-initialized for an application that is already running. Hence, in one embodiment, when an application is started, the used-up standby process is typically not immediately replaced with a similar process. Rather, a new preloaded process is created only when the application is closed. This also helps to keep the RAM consumption stable; starting an application which is associated with a pre-initialized rendering process generally does not consume much extra RAM. In another embodiment, the pre-initialized rendering process created after closing the application may or may not be (fully or partially) re-initialized for the application that was just closed depend on the application pre-initialization strategy.

In one embodiment, a new preloaded process is typically created at: (1) system startup or boot, (2) web application close, or (3) RAM availability increase (e.g., on closing a large native application; also note that in some embodiments the increase must persist for some time before it can be acted upon, in order to avoid thrashing which is a situation where the user closes one application and starts another).

In one embodiment, an application can also explicitly request a preloaded process to be created. For example, a JavaScript API can be provided to applications for this purpose. This is useful for applications which start other applications. For example, a photo viewer application might include the functionality to start a photo editing application. In this case, the photo viewer could explicitly request the creation of a preloaded process for the photo editor application, so that it can be started quickly when the user requests it.

In one embodiment, pre-initialized processes are created in the background (low priority) until, for instance, either a preconfigured RAM quota is filled (note that application tracing will give a RAM consumption estimate for each application; also custom pre-initialization parameters or rules, e.g., custom preload pages, may specify a RAM consumption estimate) or system free RAM drops below a preconfigured amount. The order in which pre-initialized processes are started depends on the current pre-initialization strategy, but typically the pre-initialized processes for the most used applications would be started first.

In one embodiment, the strategy for selecting applications and libraries for pre-initialization may take into consideration things such as:
Observed application/library usage frequency by the user (possibly with recent usage having heavier weight)
Observed application/library usage frequency by other users (possibly limited to users who are in some way similar to the current user—note, if this is not done dynamically it becomes more of a static rule, see next bullet)
Static rules based on a priori knowledge (e.g., common JavaScript libraries and traditional core applications such as Contacts and Calendar, also applications/libraries known to be commonly used based on user studies)
Explicit user actions that implicate importance of an application (e.g., marking an application as Favorite or putting a shortcut to the application on the phone's desktop/idle screen)
Observed application usage patterns of the user and associated context information (e.g., user might use game applications predominantly outside work hours, and productivity applications predominantly during work hours)
Observed usage patterns from other users (in one embodiment, the observations are limited to users who are in some way similar to the current user)

In one embodiment, since the pre-initialized rendering processes are primarily a speed optimization, they can be killed at any time. This allows the pre-initialization mechanism to quickly adapt to changing RAM or other device resource conditions. For example, if RAM is running low, all or some of the pre-initialized rendering processes can be killed (e.g., kill order would be according to current pre-initialization strategy, such as reverse starting order). If there is plenty of RAM, the browser can prefer to use fully pre-initialized standby processes for commonly used apps. In an average-RAM-availability situation, the rendering processes for a few top applications can be fully pre-initialized and some commonly used apps and libraries would be partially pre-initialized.

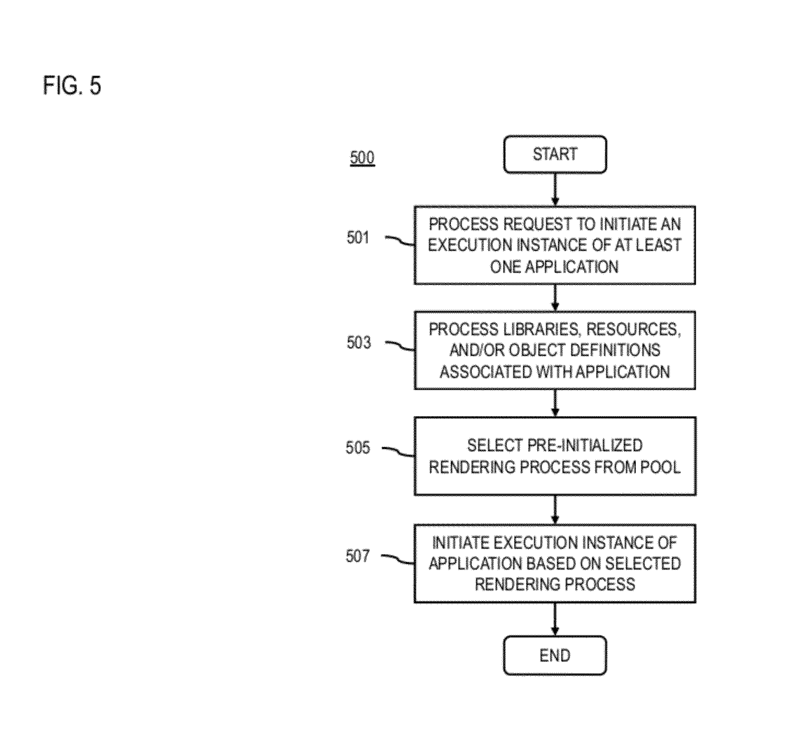

FIG. 5 is a flowchart of a process for initiating an execution instance of an application based on a pool of pre-initialized rendering processes, according to one embodiment. In one embodiment, the process management platform 103 performs the process 400 and is implemented in, for instance, a chip set including a processor and a memory as shown in FIG. 9. In addition or alternatively, one or more of the modules 105a-105d of the UE 101 may perform all or a portion of the process 400.

At step 501, the process management platform 103 processes and/or facilitates a processing of a request to initiate an execution instance of at least one application. Next, the process management platform processes and/or facilitates a processing of one or more libraries, one or more resources, one or more object definitions, or a combination thereof associated with the at least one application (step 503). In other words, the process management platform identifies the specific components (e.g., libraries, resources, object definitions, etc.) used by a particular application. As discussed previously, one or more of the libraries, resources, object definitions, etc. may be common to several applications.

Next, the process management platform 103 determines to cause, at least in part, a selection of the at least one rendering process from among a pool of one or more pre-initialized rendering processes based, at least in part, on the one or more libraries, the one or more resources, the one or more object definitions, or a combination thereof (step 505). For example, the process management platform 103 can select a pre-initialized rendering process that includes one or more preloaded components of the application. As noted above, a rendering process may be pre-initialized with common components or components specific to a particular application. If an appropriate pre-initialized rendering process is available, then the process is selected.

The process management platform 103 then determines to initiate the execution instance of the at least one application based, at least in part, on the selected at least one rendering process (step 507). In this case, initiating the execution instance of the application in the pre-initialized rendering process reduces application startup time by ensuring that at least a portion of the components of the application is already on standby and available for immediate use in response to the execution request.

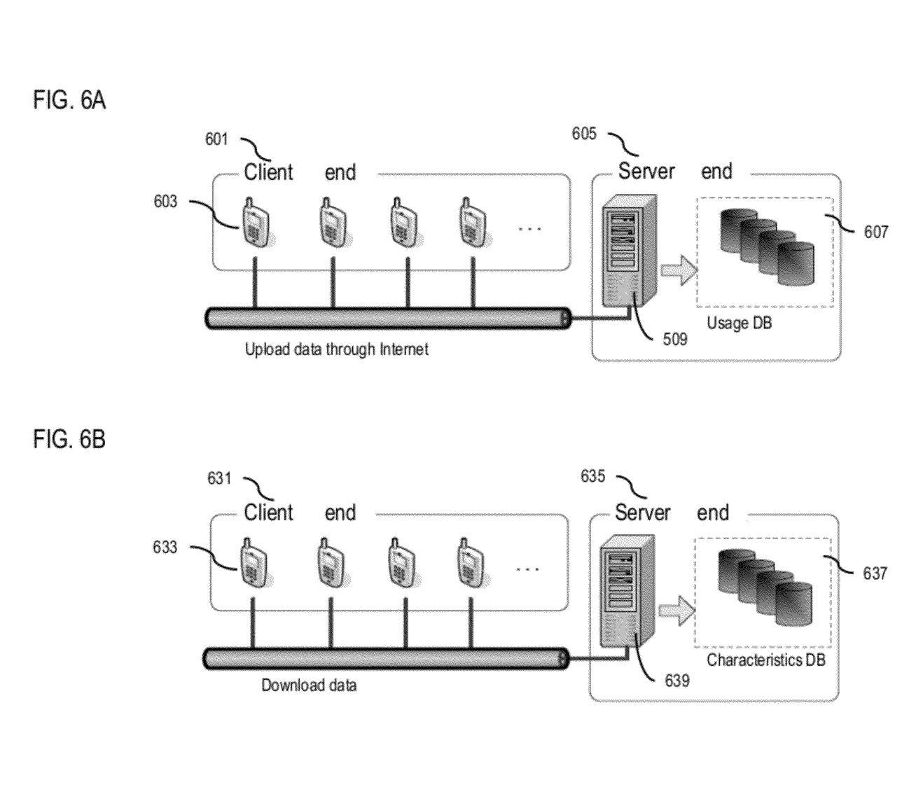

FIGS. 6A and 6B are diagrams of interactions between a client and a server utilized in data mining included in the pre-initialization processes of FIGS. 1-5, according to various embodiments. FIG. 6A shows that data such as resource usage data monitored at the client end 601 from mobile devices 603 (e.g., UEs 101a-101n), may be uploaded to the server end 605 through the Internet (e.g., communication network 105). In one embodiment, the server end 605 may include the process management platform 103. At the server end 605, the uploaded data is stored in the usage database 607. Once the uploaded data is processed by the server, i.e., after data mining and personalization, it can then be downloaded to the client. This embodiment is advantageous in that the mobile devices 603 can reduce their computational burdens associated with the data mining to the server 609. It is noted that the server 609 generally has more processing power and related resources (e.g., bandwidth, memory, etc.) than the mobile devices 603 to handle this type of computation.

Alternatively, as shown in FIG. 6B, the data retrieved (downloaded) by the mobile devices 633 at the client end 631 may be stored at storage media (not shown) of the respective mobile devices 633. The mobile devices 633 may then locally perform the computations for generating application characteristic data 109a. Then, if permission is granted, the result of the computation (e.g., the client-end application characteristic data) may be uploaded to the server end 635 including a server 639 and application characteristic database 637. This embodiment is advantageous in that the data is kept within the respective mobile devices 633, and is not uploaded to other devices or servers without the user's permission. As long as the mobile device 633 has the data and sufficient processing power to analyze the data, then the server 639 may not be required to perform the analysis.

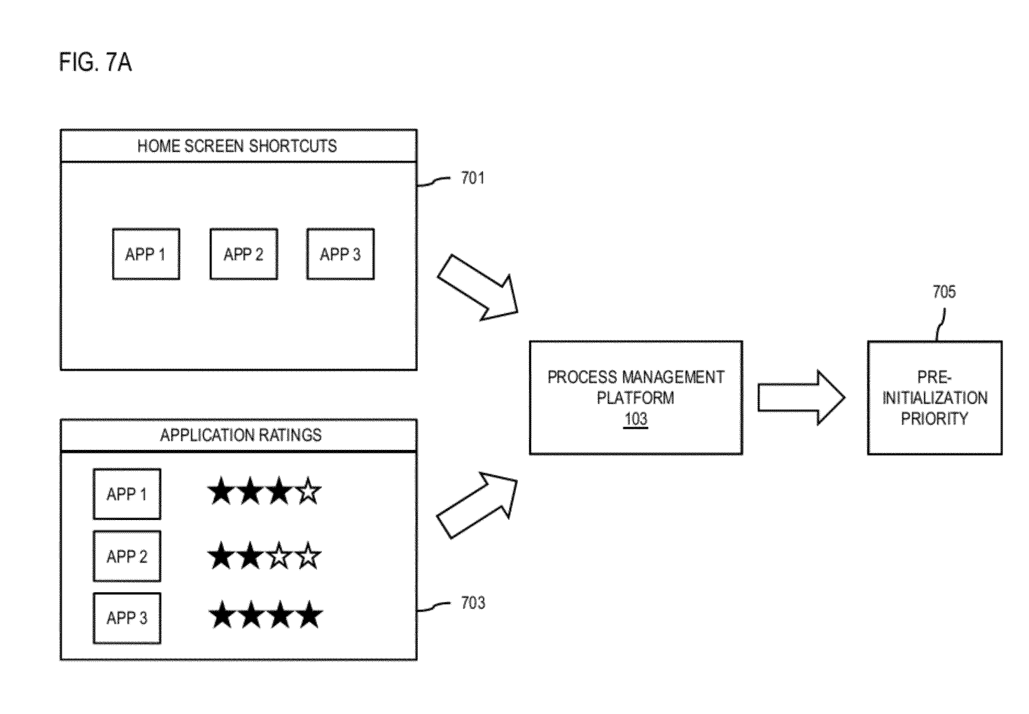

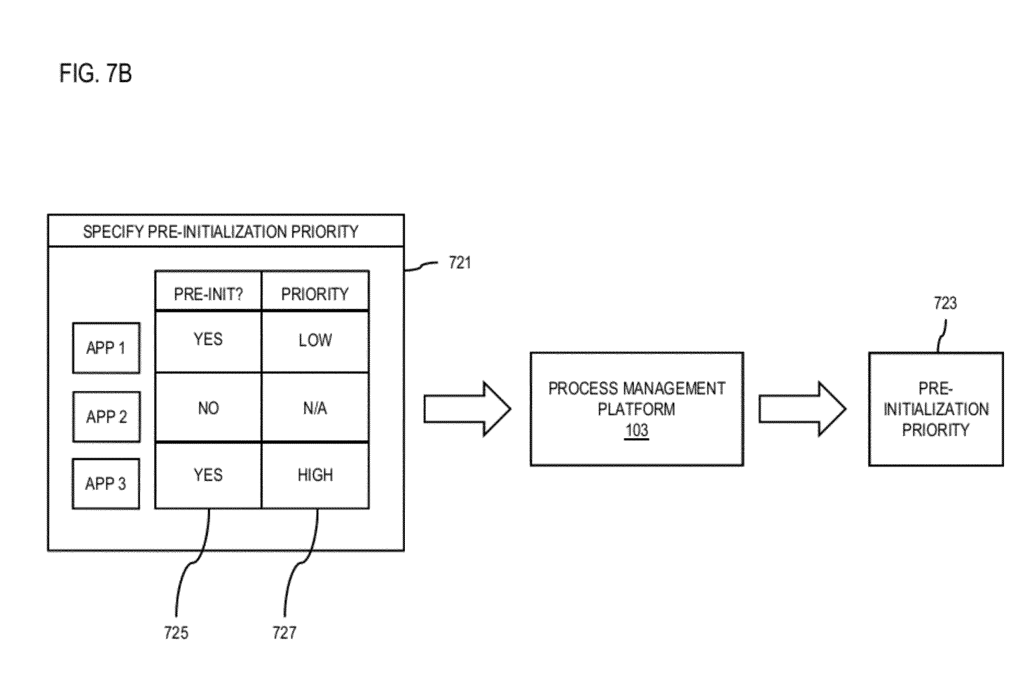

FIGS. 7A and 7B are diagram of user interfaces used in the processes of FIGS. 4 and 5, according to various embodiments. In one embodiment, the user interfaces of FIGS. 7A and 7B include functionality and are generated based, at least in part, on data, information, and/or signals resulting from any of the processes of the various embodiments of the pre-initialization process described herein. As shown, FIG. 7A depicts user interfaces (UIs) 701 and 703 for implicitly indicating application priority for pre-initialization. In other words, the UEs 701 and 703 provide indirect means for indicating the priority. In this example, UI 701 depicts a device home screen containing user definable application shortcuts. As shown, the user has selected to create shortcuts to APP 1, APP 2, and APP 3. The process management platform 103 can monitor the shortcut as an indicator of the relative importance or priority of the application to the user. For example, if an application with a shortcut on the home screen is likely to be of greater importance to the user than an application that does not have a shortcut.

Similarly, UI 703 depicts a means for indirectly learning the priority of applications with respect to a particular user. In this case the UI 703 is an interface for a user to rate particular applications. For example, the UI 703 may be part of an application store or other online application repository where users can rate various applications or web applications. As shown, the UE 703 lists APP 1, APP 2, and APP 3 and provides for input of corresponding ratings from the users. The process management platform 103 can then use the ratings information of the UI 703 and/or the shortcut information of the UI 701 to determine a pre-initialization priority 705. By way of example, the pre-initialization priority 705 can be used to determine which rendering processes for which applications and in which order are to be pre-initialized at a particular's user device.

FIG. 7B depicts a UI 721 for a user to manually specify the pre-initialization priority 723 for use by the process management platform 103. As shown, the UI 721 lists APP 1, APP 2, and APP 3 and provides a column 725 for specifying whether (e.g., yes or no) to pre-initialize corresponding rendering processes for the respective application, and a column 725 for indicating a priority (e.g., high or low) for those applications selected for pre-initialization. In one embodiment, the process management platform 103 can create the pre-initialization priority 723 based solely on the manual specifications of the UI 721. In another embodiment, the process management platform 103 can also take into account implicit application characteristics (e.g., the characteristics determined as part of the UIs 701 and 703) in combination with the manual specification to generate the pre-initialization priority 723.

The processes described herein for pre-initializing application rendering processes may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

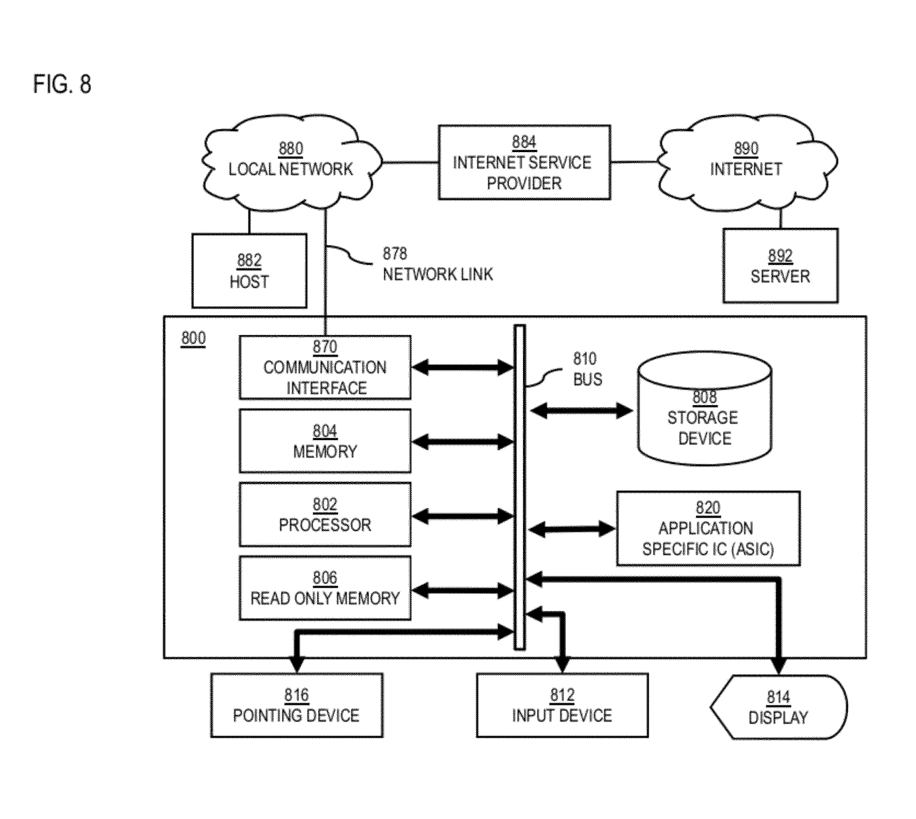

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to pre-initialize application rendering processes as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of pre-initializing application rendering processes.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to pre-initializing application rendering processes. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for pre-initializing application rendering processes. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for pre-initializing application rendering processes, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for pre-initializing application rendering processes.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to pre-initialize application rendering processes as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of pre-initializing application rendering processes.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to pre-initialize application rendering processes. The memory 905 also stores the data associated with or generated by the execution of the inventive steps.

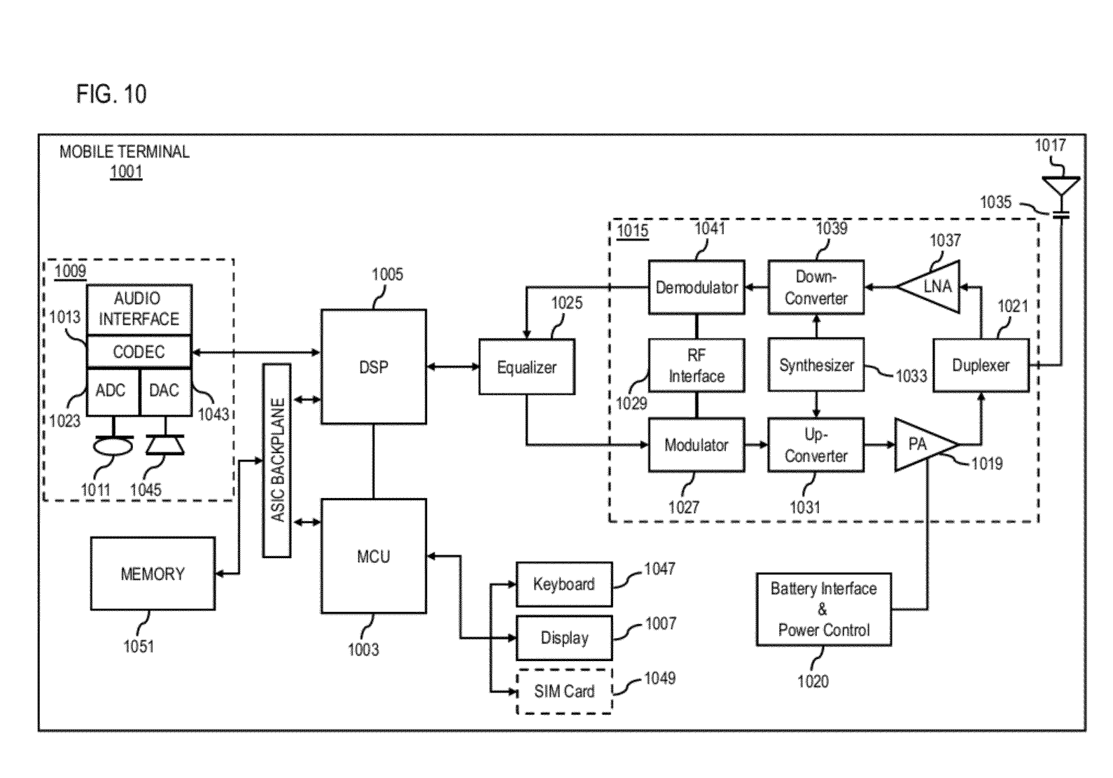

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of pre-initializing application rendering processes. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of pre-initializing application rendering processes. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to pre-initialize application rendering processes. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a processing of one or more characteristics of at least one application for rendering at a device; and
an initialization of at least a portion of at least one rendering process at the device for supporting the at least one application based, at least in part, on the one or more characteristics,
wherein the initialization occurs prior to receiving a request to initiate an execution instance of the at least one application.

2. A method of claim 1, wherein the (1) data and/or (2) information and/or (3) at least one signal are further based, at least in part, on the following:
a monitoring of one or more prior execution instances of the at least one application; and
a processing of the monitoring for determining the one or more characteristics.

3. A method of claim 1, wherein the one or more characteristics include, at least in part, a use pattern, a frequency of use, a priority, a classification, a context, a preference, or a combination thereof of the at least one web application.

4. A method of claim 1, wherein the initialization causes the (1) data and/or (2) information and/or (3) at least one signal to be based, at least in part, on the following:
a preloading into the at least one rendering process of one or more libraries, one or more resources, or a combination thereof associated with the at least one application.

5. A method of claim 4, wherein the preloading is based, at least in part, on a determination of whether the one or more libraries, the one or more resources, or a combination thereof are available locally, remotely, or a combination thereof.

6. A method of claim 1, wherein the (1) data and/or (2) information and/or (3) at least one signal are further based, at least in part, on the following:
the request to initiate the execution instance of the at least one application;
one or more libraries, one or more resources, one or more object definitions, or a combination thereof associated with the at least one application;
a selection of the at least one rendering process from among a pool of one or more pre-initialized rendering processes based, at least in part, on the one or more libraries, the one or more resources, the one or more object definitions, or a combination thereof; and
a determination to initiate the execution instance of the at least one application based, at least in part, on the selected at least one rendering process.

7. A method of claim 1, wherein the (1) data and/or (2) information and/or (3) at least one signal are further based, at least in part, on the following:
one or more initialization parameters, one or more initialization rules, or a combination thereof associated with the at least one application,
wherein the initialization is based, at least in part, on the one or more initialization parameters.

8. A method of claim 1, wherein the initialization is performed on a system startup, an application close, a change in resource availability, on request, or a combination thereof.

9. A method of claim 1, wherein the initialization is based, at least in part, on whether the at least one application is on a whitelist or a blacklist.

10. A method of claim 1, wherein the at least one application is a web application.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of one or more characteristics of at least one application for rendering at a device; and
cause, at least in part, an initialization of at least a portion of at least one rendering process at the device for supporting the at least one application based, at least in part, on the one or more characteristics,
wherein the initialization occurs prior to receiving a request to initiate an execution instance of the at least one application.

12. An apparatus of claim 11, wherein the apparatus is further caused to:
determine to cause, at least in part, monitoring of one or more prior execution instances of the at least one application; and
process and/or facilitate a processing of the monitoring for determining the one or more characteristics.

13. An apparatus of claim 11, wherein the one or more characteristics include, at least in part, a use pattern, a frequency of use, a priority, a classification, a context, a preference, or a combination thereof of the at least one web application.

14. An apparatus of claim 11, wherein the initialization causes the apparatus to:
determine to cause, at least in part, a preloading into the at least one rendering process of one or more libraries, one or more resources, or a combination thereof associated with the at least one application.

15. An apparatus of claim 14, wherein the preloading is based, at least in part, on a determination of whether the one or more libraries, the one or more resources, or a combination thereof are available locally, remotely, or a combination thereof.

16. An apparatus of claim 11, wherein the apparatus is further caused to:
process and/or facilitate a processing of the request to initiate the execution instance of the at least one application;
process and/or facilitate a processing of one or more libraries, one or more resources, one or more object definitions, or a combination thereof associated with the at least one application;
determine to cause, at least in part, a selection of the at least one rendering process from among a pool of one or more pre-initialized rendering processes based, at least in part, on the one or more libraries, the one or more resources, the one or more object definitions, or a combination thereof; and
determine to initiate the execution instance of the at least one application based, at least in part, on the selected at least one rendering process.

17. An apparatus of claim 11, wherein the apparatus is further caused to:
process and/or facilitate a processing of one or more initialization parameters, one or more initialization rules, or a combination thereof associated with the at least one application,
wherein the initialization is based, at least in part, on the one or more initialization parameters.

18. An apparatus of claim 11, wherein the initialization is performed on a system startup, an application close, a change in resource availability, on request, or a combination thereof.

19. An apparatus of claim 11, wherein the initialization is based, at least in part, on whether the at least one application is on a whitelist or a blacklist.

20. An apparatus of claim 11, wherein the at least one application is a web application.

21.-48. (canceled)
